(19) United States
(12) Patent Application Publication
(10) Pub. No.: US 2025/0376973 A1
(43) Pub. Date: Dec. 11, 2025

(54) ROTATIONAL WHEEL SYSTEM BY COMPOUND ACTUATION

(71) Applicant: Ming-Tung HUNG, Taipei City (TW)

(72) Inventor: Ming-Tung HUNG, Taipei City (TW)

(21) Appl. No.: 18/736,115

(22) Filed: Jun. 6, 2024

(51) Int. Cl. F03G 3/04; F03G 3/00

(52) U.S. Cl. CPC F03G 3/04; F03G 3/087

(57) ABSTRACT

Provided is a rotational wheel system by a compound actuation, including a wheel including a horizontal rotation shaft and divided into equal directions in all-around orientations. Each direction has two slidable members connected by a transmission system. One is disposed with a container to hold substance from an auxiliary system for transporting the substance, and the other gradually reduces an inclination angle with a plane when the wheel rotates. The slidable members whose weight increases due to the substance slide down and move another slidable member through the transmission system to change a force arm length to produce a torque on the rotation shaft. The slidable member with the container to hold the substance also produces the torque in the same direction on the rotation shaft. The present invention uses two or more different actuation systems to jointly make the wheel generate a rotation kinetic energy.

### BACKGROUND OF THE INVENTION

### 1. Field of the Invention

The present invention relates generally to a device able to generate a kinetic energy, and more particularly, to a wheel able to rotate in a compound actuation manner.

### 2. The Prior Arts

With the development of human civilization, energy consumption is increasing rapidly. Shortage of electricity or pollution becomes serious concerns. Decentralized and diversified energy development is the trend. Finding clean and reliable alternative energy sources is an urgent priority for mankind.

Among various alternative energy sources, water power, wind power, and solar power are more recognized and adopted, but with respective limitations and issues, such as insufficient water, small gap, water shortage season, windless season, too little wind, occupying too large an area, cloudy or rainy days, dark at night, or insufficient sunshine. In short, alternative energy sources are often unstable and require the assistance of energy storage equipment. The overall cost is not low, which is a big concern. There are also hidden social costs such as pollution due to energy storage.

Existing rotational wheels, such as ordinary water wheels or wind wheels, have a single actuation to rotate their rotation shafts. For example, due to the increasing shortage of water resources and even drought, it is difficult for water wheels to cope with the large amount of water resources or the traditional power generation method that requires much height difference. To overcome the single actuation restriction, a possible approach is to adapt the water wheels to a low water level, use less water, use stepped water, or even use other substances other than water for actuation. These are all possible directions for water wheels to be considered in present development.

### SUMMARY OF THE INVENTION

Based on the above reasons, the present invention discloses a device for generating kinetic energy by performing a compound actuation on a rotation shaft. Through two or more different systems of actuating the rotation shaft, a strong torque is generated to develop a clean, cheap, stable and reliable energy for use.

The present invention uses water or other bulk substances as an auxiliary, and can use only a small amount of water in areas where water resources are scarce, at a specific stage of the water transport process, or use a suitable water source with a high water level and which can be installed with a ladder below as a water source. It can place the wheel at the substance drop point of the conveyor belt of bulk substances such as ore and grain, making full use of the weight of the fluid or bulk substances to develop kinetic energy as an auxiliary to increase the imbalance of the system. It is a compound gravity wheel that uses the labor-saving principle of slope and combines different energy factors such as gravity, torque, and inertia. It can also be assisted by different dry and wet substances, and has a wide range of applications.

The present invention provides a rotational wheel system by a compound actuation, including: a wheel comprising a horizontal rotation shaft and a plurality of radial members arranged into arrays in equally divided directions. The radial members are fixed to the horizontal rotation shaft and rotate along with the horizontal rotation shaft to form a wheel. Each of the radial members includes: a first smooth member; a first slidable member, slidably coupled to the first smooth member; a second smooth member; a second slidable member, slidably coupled to the second smooth member; a transmission system, connecting the first slidable member and the second slidable member to enable the downward sliding of the first slidable member to drive the second slidable member to slide, and both change the length of the force arm.

Both the first slidable member and the second slidable member are restricted in sliding ranges through two blocking members. The two blocking members are provided on the first smooth member and the second smooth member, and may also be provided on d radial members or other elongated structures coupled to the smooth members; the blocking member does not hinder the passage of the transmission system, and may also have a configuration or holes that are conducive to the passage of the transmission system.

The first smooth member and the second smooth member form a certain included angle with each other, and the included angle is between 45° and 90°.

When the first slidable member slides on the first smooth member, the first slidable member will pull the second slidable member to slide on the second smooth member through the transmission system, and the driven second slidable member will be pulled by the force at a certain slope angle to increase the weight through the labor-saving principle of slope.

The actuation of the wheel is jointly implemented by a first actuation system and a second actuation system; the first actuation system includes the first slidable member, a container, engaged with the first slidable member to hold substances; the substance contained in the container; the second actuation system includes the second slidable member.

Because of weight increase due to the second slidable member and after being pulled, the second actuation system on one side of the vertical shaft moves to the outside farther away from the rotation axis, and the second actuation system on the other side of the vertical axis moves inward closer to the rotation axis, the second actuation system formed by the second slidable member generates a large torque in one direction on the rotation axis.

Weight of first slidable member:

1. The case wherein the first slidable member is lighter:

The first slidable member is engaged to two containers with different opening directions to hold substances; the total weight of the first slidable member and the two containers is lower than the weight of the second slidable member; before loaded with substances, the total weight of the first slidable member and the containers is insufficient to fall downward when the first smooth member is vertical to the horizontal plane, and cannot pull the second slidable member; but,

An auxiliary system for transporting substances is provided, independently arranged on the side of the wheel to send, at two different specific directions, the substance into two containers with different opening directions engaged to the first slidable member; the total weight of the substances, the first slidable member and the two containers together makes the first slidable member fall or slide down, and drive the second slidable member to slide through the transmission system.

The auxiliary system for transporting substances has two substance outlets located at different heights; one of which is to load the substance into one of the containers of the first slidable member at the orientation when the first slidable member rotates along with the wheel and the opening of one of the containers within a 45° range between the vertical axis at 12 o'clock direction to 1:30 o'clock direction, and the substance is transported into the container from high position; the other is the to load the substance into the other container of the first slidable member at the orientation the first slidable member rotates along with the wheel and the opening of the other container within a 60° range between the 6 o'clock direction and 8 o'clock direction, and the substance is transported into the other container from high position; when the first slidable member rotates with the wheel, and the other container is located between 6 o'clock and 8 o'clock in the 60° position, the substance is transported to the other container from a low position and from the side.

Regardless of whether the substance is transported from a high position to one container, or from a low position to the other container, the weight of the first slidable member increases suddenly because a container receives the substance and produces the following effects: 1. rapidly falling or sliding down, and drives the second slidable member to slide through the transmission system; or 2. even though the weight increases, the inclination angle becomes larger as the wheel rotates, and then slides down, and the second slidable member is pulled through the transmission system to slide.

The container of the first slidable member receiving the substance at a higher position, after loaded with substance, not only helps the first actuation system to generate positive torque in the direction of operation, but also causes the first slidable member to drop downwards to cause the second slidable member to slide to the side away from the rotation axis, which increases the length of the force arm when the second slidable member generates a positive torque in the rotating direction, and increases the force of the second actuation system in the rotating direction.

The configuration of the container receiving the substance at a higher position and the opening direction after being engaged with the first slidable member are to allow the substance to remain in the container for a long time before being discharged and unloaded when the wheel is rotating so as to enable the substance weight to exert greater power on the wheel.

The other container receiving the substance at a lower position can also cause the first slidable member to drop or slide downwards after loaded with the substance, thereby causing the second slidable member to slide toward the side closer to the rotation axis, thus reducing the length of the force arm when the second slidable member generates torque in the reverse direction of operation and thus reduces the negative torque of the second actuation system in the reverse direction. After the container is engaged with the first slidable member and the other container, the opening direction and the configuration for easy discharge of substances only allow the substances to stay in the container for a short time; that is, the substances are completely discharged as the wheel rotates, which reduces the torque caused by the substance weight on the rotation shaft in the opposite rotation direction.

The first slidable member has a container that is loaded with substance at a high position with the range between about 12 o'clock and 1:30 directions. When the container moves to about the vertical axis at 6 o'clock below, all the contents are dumped. The substance is opposite to the axis of rotation. The amplitude of the positive torque generated in the clockwise direction by the substance on the rotation axis is larger, about 130°; on the other hand, the other container receiving the substance at a low position within the range between 6 o'clock to 8 o'clock directions moves to the 9 o'clock position. All the contents will be dumped before the horizontal axis, and the amplitude of the negative torque generated in the counterclockwise direction by the substance on the rotation axis is smaller, about 45°.

The first actuation system would originally have been in a steady state, but because the auxiliary system for transporting substances loads substances into the two containers at different heights, the substances in the two containers with different opening directions have different amplitudes of torsion on the rotation axis; therefore, the first actuation system breaks the steady state due to the assistance of substance and generates positive torque on the rotation shaft in the clockwise direction.

In the second actuation system, the length of the force arm of the second slidable member generating the torque in the clockwise direction is enlarged and lengthened within the range between approximately 1:30 and 6 o'clock directions; the length of the force arm of the second slidable member generating the torque in the counterclockwise direction is shrunk and shortened within the range between approximately about 7 o'clock and 12 o'clock directions, so the second actuation system will generate a huge torque in the clockwise direction of the rotation axis.

Both the first actuation system and the second actuation system generate torques in the same direction on the rotation shaft, so that the wheel can generate a good rotational kinetic energy.

2. The case wherein the first slidable member is heavier:

The first slidable member is engaged with a container able to hold substances. When the first smooth member coupled with the first slidable member is vertical to the horizontal plane, or has a considerable inclination, the total weight of the first slidable member together with the first smooth member and the empty container is sufficient to fall or slide down and moves the second slidable member to slide through the transmission system, whether it is at the high position within the range between 12 o'clock to 3 o'clock directions or the low position within the range between 6 o'clock to 9 o'clock direction.

An auxiliary system for transporting substances is independently arranged on the side of the wheel. The auxiliary system sends the substance into the container of the first slidable member from a high position and at a position where the first slidable member moves along with the rotation of the wheel, and the opening of the container is within the 45° range between the 12 o'clock vertical axis and the 1:30 direction.

Due to the configuration of the container engaged with the first slidable member and the opening direction of the container after being engaged with the first slidable member, the container tilts when moving to the vicinity of the vertical axis at the 6 o'clock position with the rotation of the wheel and unload all the substance in the container from the auxiliary system, uses the substance weight to increase the positive torque on the rotation axis in the rotation direction, and the substance only produces positive torque on the rotation axis in the rotation direction without increasing the resistance in the reverse direction of operation.

The first actuation system only has substance weight on one side of the vertical axis to increase the torque on the rotation axis, but not on the other side. The first actuation system, which would have been in a steady state, generates a torque on the rotation shaft in the clockwise direction due to the substance input from the auxiliary system.

When the second slidable member of the second actuation system generates a torque on the rotation shaft in the clockwise direction, the second slidable member is pulled to the outside away from the rotation shaft, that is, to the range between about 1:30 and 6 o'clock directions. The length of force arm is enlarged and lengthened; when a torque in the opposite rotation direction is generated on the rotation shaft, the second slidable member is pulled to the inside of the rotation shaft, that is, to the range between about 7:30 and 12 o'clock directions. The length of force arm is reduced and shortened, so the second actuation system will generate a huge torque in the clockwise direction of the rotation axis.

Both the first actuation system and the second actuation system generate torques in the same direction on the rotation shaft, so that the wheel can generate a good rotational kinetic energy.

The first slidable member and the second slidable member may comprise two overlapping parts that are slidable with respect to each other, and the two overlapping parts will change and increase the length of the slidable member after respective sliding. Because the slidable member extending the length to change the length of the force arm of the center of gravity, when a torque is generated on the rotation axis in the rotation direction, the length of the force arm of the center of gravity will increase to increase the positive torque on the rotation axis; when a torque in the opposite rotation direction is generated on the rotation axis, the length of the force arm of the center of gravity will be shortened to reduce the reverse torque on the rotation axis.

According to an embodiment of the present invention, the edge of the radial member away from the rotation axis is engaged with a long strip structure perpendicular to the radial member, and the outward side of the long strip structure is engaged with a first smooth member and the side of the radial member in the opposite rotation direction are engaged with a second smooth member, and an angle between a virtual extension line of the second smooth member and the first smooth member is 90°.

According to an embodiment of the present invention, the first slidable member is engaged with two containers for holding substances with different opening directions, the total weight of the first slidable member together with two containers is less than the weight of the second slidable member, and before the substance is loaded into the containers, the total weight of the containers and the first slidable member is insufficient to fall down and pull the second slidable member when the first smooth member engaged with the first slidable member is at the high position vertical to the horizontal plane.

However, there is an auxiliary system for transporting substances independently arranged on the side of the wheel. The auxiliary system has two substance outlets, one of which transports substances to a container of the first slidable member at the 1 o'clock position; the other substance outlet transports the substance to another container of the first slidable member from the left or right side of the rotating wheel at the 7:30 position; the first slidable member is made to slide down with the assistance of the weight of the substance.

According to an embodiment of the present invention, each set of transmission systems includes two rope-like strip transmission members and five sets of pulleys; wherein one rope-like strip transmission member passes through two sets of pulleys, and the other goes through three sets of pulleys.

According to an embodiment of the present invention, the blocking member limiting the sliding range of the first slidable member and the second slidable member is provided at both ends of the first smooth member and the second smooth member.

According to an embodiment of the present invention, the first slidable member and the second slidable member slide for the same distance.

According to an embodiment of the present invention, the smooth member comprises two parallel circular strips, the slidable member has two circular parallel through holes, and the circular parallel through holes sheath the parallel circular strips to make the slidable member slidable.

According to an embodiment of the present invention, one side of the slidable member has an I-shaped protrusion, and one side of the smooth member has a groove into which the I-shaped protrusion can be inserted; the protrusion is inserted into the groove to make the slidable member become slidable.

According to an embodiment of the present invention, the radial member is flat and also serves as the first smooth member with one side facing the rotating direction disposed with a strip-shaped member; the strip-shaped member is flat and serves as the second smooth member; both the first slidable member and the second slidable member have slide grooves that are slightly wider to accommodate the first and second smooth members to facilitate sliding.

According to an embodiment of the present invention, the radial member is flat and also serves as the second smooth member with one side opposite to the rotating direction disposed with a strip-shaped member; the strip-shaped member is flat and serves as the first smooth member; both the first slidable member and the second slidable member have slide grooves that are slightly wider to accommodate the first and second smooth members to facilitate sliding.

According to an embodiment of the present invention, each set of transmission systems includes two rope-like strip transmission members and four sets of pulleys, and each rope-like strip transmission member passes through two sets of pulleys.

According to an embodiment of the present invention, each rope-like strip transmission member has one end engaged with the first slidable member and the other end engaged with the second slidable member, so that the sliding kinetic energy of the first slidable member pulls the second slidable member.

According to an embodiment of the present invention, the pulleys of each pulley set have deeper, wider and U-shaped grooves, and each of the two rope-like strip transmission members passing through the pulley set are not in a tight state, but in a state that is slightly loose but does not cause the rope-like strip transmission member to loosen from the pulley, which is beneficial to the operation of the transmission system.

According to an embodiment of the present invention, the blocking member that limits the sliding range of the first slidable member and the second slidable member is disposed at appropriate locations other than both ends of the first smooth member and the second smooth member.

According to an embodiment of the present invention, the blocking member that limits the sliding range of the first slidable member and the second slidable member is provided at an appropriate place on the radial member or elongated structure.

According to an embodiment of the present invention, the first slidable member is engaged with a container for holding a substance, and the first slidable member together with the container is sufficient to fall or slide down without the assistance of the weight of the substance when the first smooth member engaged with the first slidable member is perpendicular to the horizontal plane or has a considerable inclination, and the second slidable member is pulled by the transmission system to slide; the substance is input between the 45° position between 12 o'clock and 1:30 directions and by virtue of the configuration and opening direction of the container, the substance is unloaded near the vertical axis at 6 o'clock, so that the substance only increases the positive torque on the rotation axis without increasing reverse resistance.

According to an embodiment of the present invention, each transmission systems further includes two identical compound winch kits, the two compound winch kits are interspersed in different pulley groups and can replace the pulley sets and the number of rope-like strip transmission members is increased to four:

The two ends of the first slidable member facing the sliding direction are each engaged with a rope-like strip transmission member; the pulley set passed by each rope-like strip transmission member is provided with a compound winch kit; the other end of each rope-like strip transmission member is each engaged with a small winch of a compound winch kit;

The two ends of the second slidable member facing the sliding direction are also engaged with a rope-like strip transmission member, and the other ends of the two rope-like strip transmission members are each engaged with a large winch of a compound winch kit;

As such, the sliding distance of the first slidable member is smaller than the sliding distance of the second slidable member, which can increase the length of the force arm when the second slidable member generates torque in the rotating direction.

According to an embodiment of the present invention, the two compound winch kits are identical and comprise a large winch and a small winch, arranged in a coaxial manner and rotating synchronously; the large and small winches wind around the rope-like strip transmission member in opposite directions; when the large winch winds and tightens the connected strip-shaped transmission member, the small winch loosens the connected strip-shaped transmission member; on the other hand, when the large winch loosens the connected strip-shaped transmission member, the small winch system winds and tightens the connected strip transmission member.

According to an embodiment of the present invention, for the two compound winch kits of the same transmission system, the direction in which the large winch of one compound winch kit winds the connected rope-like strip transmission member is opposite to the direction in which the large winch of the other compound winch kit winds the connected rope-like strip transmission member; the directions of the small winches of the two compound winch kits winding the connected rope-like strip transmission member are also opposite; as such, one of the two large winches on the connected rope-like strip transmission member is in a tight state while the other is in a loosened state; and one of the two small winches on the connected rope-like strip transmission member is in a tight state while the other is in a loosened state so as to achieve transmission.

According to an embodiment of the invention, the distance the first slidable member slides is less than the distance the second slidable member slides. The length that the small winch tightens or loosens the corresponding rope-like strip transmission member is equal to the sliding distance of the first slidable member; the length that the large winch tightens or relaxes the corresponding rope-like strip transmission member is equal to the sling distance of the second slidable member.

According to an embodiment of the present invention, an appropriate part of the wheel is disposed with a concave arc-shaped force-bearing member having a convex surface facing the rotation direction, so that the wheel can also be actuated by wind as well as undertaking the overflowing water when transporting the water from a high direction to the container to increase the torque on the rotation shaft. In seasons when the water is abundant and sufficient water resources are available, more water bodies can be used to help drive the wheel. The additional wind and water power to drive the wheel is the third actuation system.

According to an embodiment of the present invention, the concave arc-shaped force-bearing member has a concave arc-shaped wide handle and is in the shape of a curved spoon to facilitate receiving and retaining water.

According to an embodiment of the present invention, the water dumped from the force-bearing member with a concave arc-shaped wide handle and a curved spoon shape will fall into another radial member of the same orientation and set that is farther away from the rotation axis so that the concave arc-shaped force-bearing member allows the water body to continue to operate on the wheel with a longer force arm.

According to one embodiment of the present invention, the water dumped from the force-bearing member with a concave arc-shaped wide handle and a curved spoon shape will fall into the container to receive substance at low position of the first slidable member in the previous direction and in the previous group, so that the water body can continue to produce torque on the rotation axis in the rotation direction before crossing the vertical axis below, so as to reduce and save the amount of water input at low positions.

According to an embodiment of the present invention, a slidable member further comprises two overlapping and slidable parts, wherein one side of the first part has an I-shaped protrusion, and one side of the second part has a groove in which the I-shaped protrusion is inserted; after the protrusion is inserted in the groove, the first part and the second part are slidable, and stop clips are disposed at the middle sections of both sides of the second part perpendicular to the side with the groove; the first part and the second part have the same length; the first part is slightly wider than or has the same width as the second part; rod-shaped protrusion protruding in the same direction as the I-shaped protrusion are disposed at appropriate places near the four corners of the first part; when the first part and the second part slide with respect to each other, the first part will stop sliding when two of the rod-shaped protrusions catch the stop clip; the stop clip and the rod-shaped protrusion are used in conjunction, so that when the two overlapping parts of the slidable member are sliding apart from each other, the sliding changes and increases the length of the slidable member, instead of completely falling apart;

As such, the slidable member will extend its length, and then two blocking members at unequal distances from the rotation axis will stop the first part and the second part at unequal distances from the rotation axis. The extended slidable member will also change the position of its center of gravity. In most cases, when a torque is exerted on the rotation shaft in the rotation direction, the length of the force arm of the center of gravity will increase and the torque on the rotation shaft is increased; when a torque in the opposite rotation direction is exerted on the rotation shaft, the length of the force arm of the center of gravity will be shortened to reduce the torque on the rotation axis.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a rotational wheel system that inputs water from the side of the wheel by an auxiliary system according to an embodiment of the present invention;

FIG. 2 is a schematic view of a rotational wheel system without showing the auxiliary system and the bracket according to another embodiment of the present invention;

FIG. 3 is a schematic view of a rotational wheel system with a transmission system including a compound winch kit (not showing the auxiliary system and the bracket) according to yet another embodiment of the present invention;

FIG. 4 is a schematic view of an implementation of a slidable member according to the present invention having two circular parallel through holes and being slidable through two parallel circular strips, and disposed with two containers with different opening directions;

FIG. 5 is a schematic cross-sectional view of an embodiment in which one side of the slidable member has an I-shaped protrusion and is inserted in a corresponding groove of the smooth member to be slidable;

FIG. 6 is a schematic view of an embodiment in which the slidable member has a slide groove and is slidable through a corresponding flat strip member;

FIG. 7 is a schematic view of a compound winch kit according to an embodiment of the present invention;

FIG. 8 is a schematic view of a compound winch kit according to another embodiment of the present invention;

FIG. 9 is a schematic view of an embodiment in which the blocking member is arranged at an appropriate place on the radial member or elongated structure, and part of the pulley is supported by extension structures;

FIG. 10 is a schematic view of an embodiment in which the wheel is disposed with a concave arc-shaped force-bearing member with a convex surface facing the rotating direction at an appropriate place;

FIG. 11 is a schematic view of another embodiment in which the wheel is disposed with a concave arc-shaped force-bearing member with a convex surface facing the rotating direction at an appropriate place;

FIG. 12 is a schematic view of yet another embodiment in which the wheel is disposed with a concave arc-shaped force-bearing member with a convex surface facing the rotating direction at an appropriate place;

FIG. 13 is a schematic view of an embodiment in which a slidable member comprises two parts that are overlapping and slidable with respect to each other according to an embodiment of the present invention;

FIG. 14 is a schematic view of another embodiment in which a slidable member comprises two parts that are overlapping and slidable with respect to each other according to an embodiment of the present invention, and the auxiliary system and the bracket of the rotational wheel system are not shown;

FIG. 15 is a schematic view of yet another embodiment in which a slidable member comprises two parts that are overlapping and slidable with respect to each other according to an embodiment of the present invention, wherein transmission system comprises a compound winch kit the and the auxiliary system and the bracket of the rotational wheel system are not shown.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

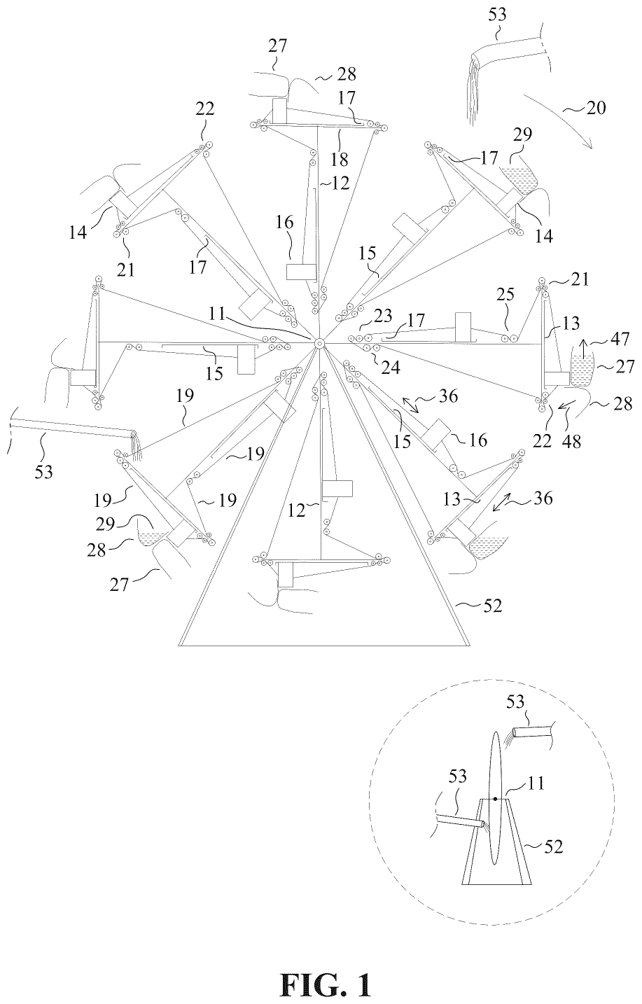

FIGS. 1, 2, and 3 are schematic views of a rotational wheel system according to three embodiments of the present invention. A wheel is equally divided around the radial directions, and each direction has a set of radial members; in all three embodiments, there is a horizontal rotation shaft 11 and multiple arrays of radial members 12 engaged with the horizontal rotation shaft 11. Each radial member has a first slidable member 14 and the first slidable member 14 is engaged with or inserted into a first smooth member 13 to be slidable; there is a second slidable member 16 engaged with or inserted into a second smooth member 15 to be slidable; the first slidable member 14 is disposed with two containers 27 and 28 with different opening directions to hold substances, the first slidable member 14 and the second slidable member 16 are connected by a rope-like strip transmission member 19, and the rope-like strip transmission member 19 passes through the necessary pulley sets 21-25 to facilitate transmission.

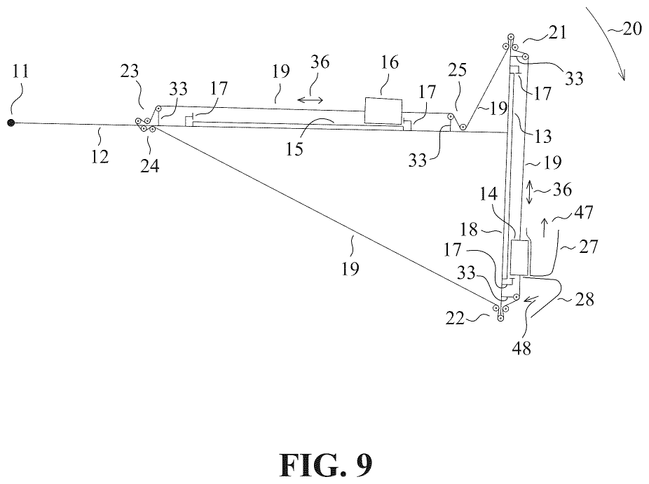

As shown in the embodiments of FIGS. 1 and 9, the edge of the radial member 12 away from the rotation axis 11 is disposed with a long strip structure 18 perpendicular to the radial member 12. The side of the radial member 12 opposite to the rotation direction is coupled to the second smooth member 15, the side of the long structure 18 facing outside is coupled to the first smooth member 13, and a virtual extension line of the second smooth member 15 is perpendicular (i.e., 90°) to the first smooth member 13.

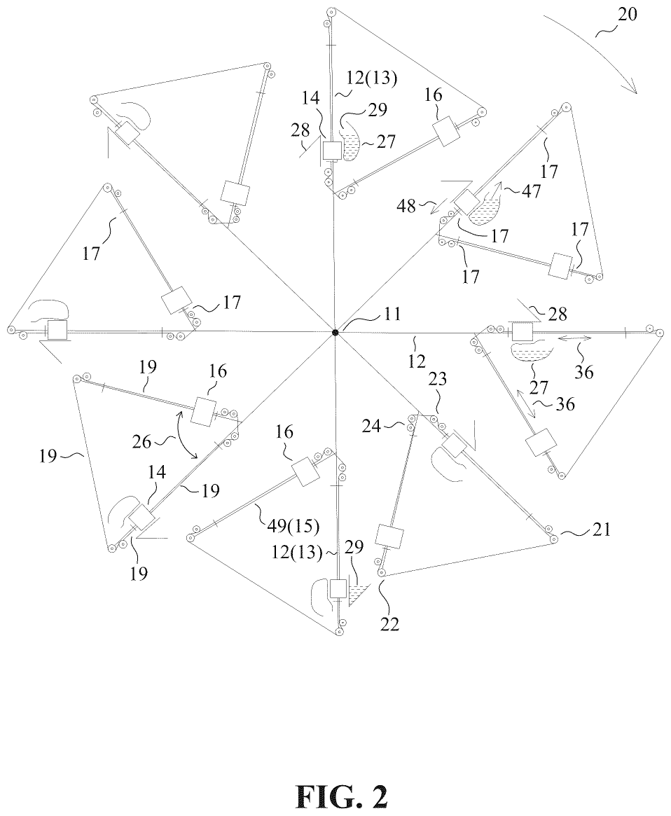

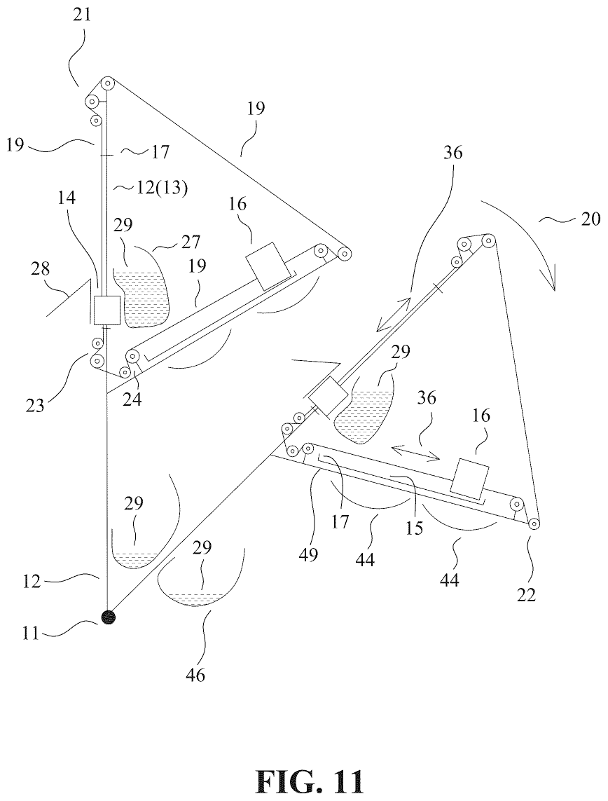

As shown in the two embodiments of FIG. 2 and FIG. 11, the radial member 12 is flat and also serves as the first smooth member (labelled as 13), and its side facing the rotation direction 20 is engaged with a flat strip-shaped member 49 at an included angle 26 of 60°. In FIG. 2, the flat strip-shaped member 49 also serves as a second smooth member (labelled as 15), and is inserted through the second slidable member 16; in FIG. 11, the second smooth member 15 is coupled to the side of the flat strip member 49 opposite to the rotation direction, and the second slidable member 16 is coupled to the second smooth member 15.

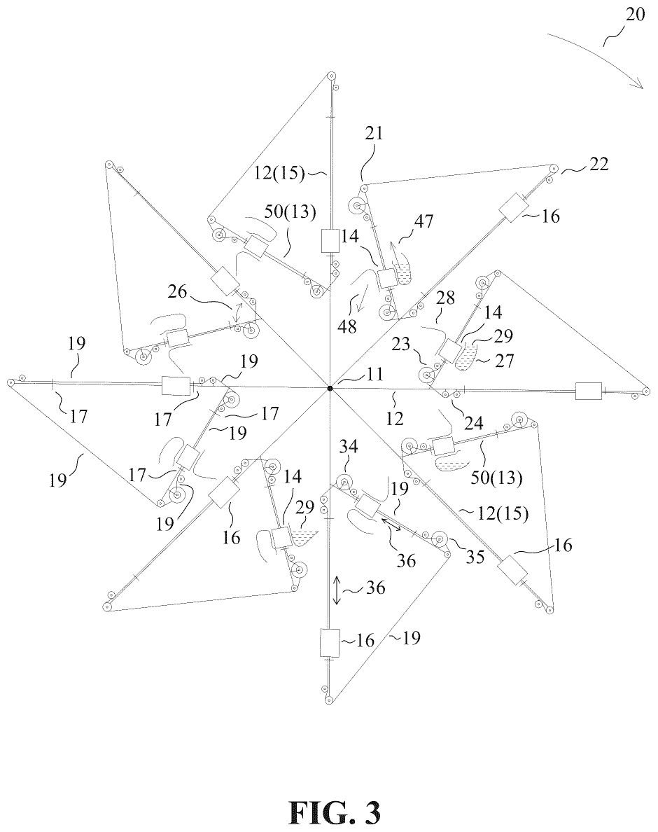

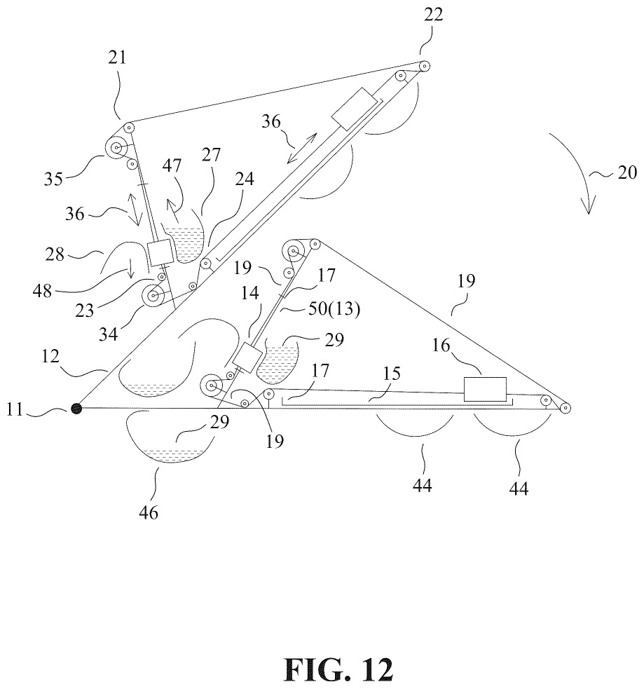

As shown in the two embodiments of FIG. 3 and FIG. 12, the side of the radial member 12 opposite to the rotation direction is engaged with a flat strip member 50 at an included angle 26 of 60°. The flat strip member 50 also serves as the second smooth member (labelled as 13), and is passed through the first slidable member 14; in FIG. 3, the radial member 12 also serves as a second smooth member (labelled as 15), and is sleeved by the second slidable member 16; in FIG. 12, the side of the radial member 12 opposite to the rotation direction is engaged with the second smooth member 15, and the second smooth member 15 is engaged with the second slidable member 16.

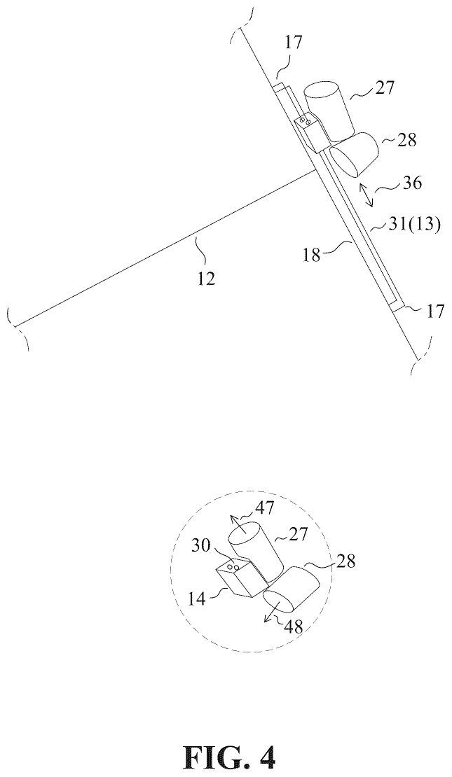

As shown in the embodiment of FIG. 4, the first smooth member (labelled as 13) comprises two parallel circular strips 31, and the first slidable member 14 has two parallel circular through holes 30. The two parallel circular strips 31 are inserted through the two parallel circular through holes 30 to make the first slidable member 14 slidable. Both edges of the parallel circular strips 31 are vertically bent to be engaged with the elongated structure 18. The small bent part serves as the blocking member 17. The above method of combining the first slidable member 14 and the first smooth member 13 to be engaged on the outward side of the elongated structure 18 can also be used as a method of combining the second slidable member 16 and the second smooth member 15 to be engaged on the one side opposite to the rotation direction of the radial member 12.

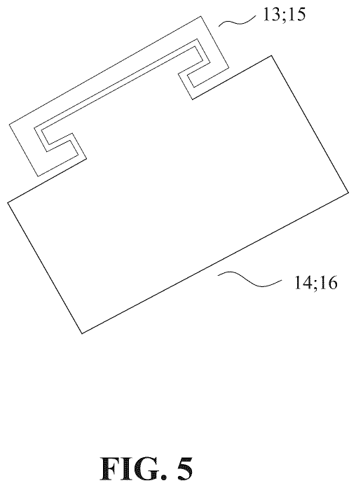

As shown in FIG. 5, one side of the smooth member 13 or 15 has a groove, and the slidable member 14 or 16 has a protrusion corresponding to the smooth member 13 or 15, and the protrusion is inserted in the groove so that the slidable member 14 or 16 is slidable.

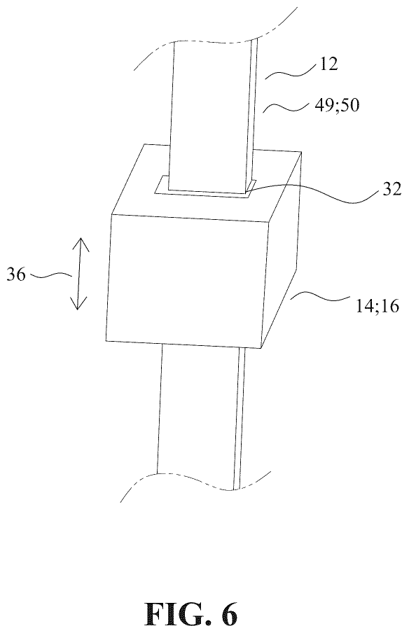

As shown in FIG. 6, the slidable member 14 or 16 has a slide groove 32, which is sleeved over the flat radial member 12 or sleeved over the flat strip member 49 or 50 so that the slidable member 14 or 16 is slidable.

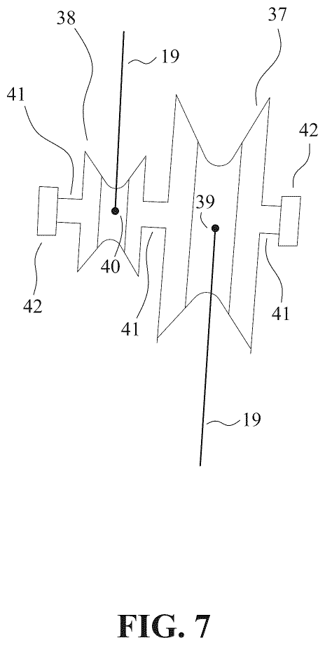

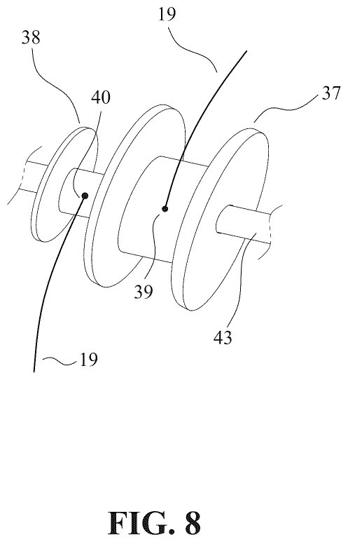

In the embodiments of FIGS. 3, 10, and 12, compound winch kits 34 and 35 are provided, and the number of rope-like strip transmission members 19 is increased to four. With the compound winch kits shown in FIGS. 7 and 8, it can be seen that each compound winch kit has a large winch 37 and a small winch 38, and the large and small winches 37 and 38 are each engaged with a rope-like strip transmission member 19. The large winch 37 and the small winch 38 rotate synchronously but wind up the rope-like strip transmission members 19 in opposite directions. When one winch of the same compound winch kit winds and tightens the rope-like strip transmission member 19, the other winch loosens the rope-like strip transmission member 19.

Both ends of the first slidable member 14 and the second slidable member 16 toward the sliding direction 36 are each coupled with a rope-like strip transmission member 19. The ends of the two rope-like strip transmission members 19 coupled to the first slidable member 14 are respectively engaged with the small winches 38 of the compound winches 34 and 35. The ends of the two rope-like strip transmission members 19 coupled to the second slidable member 16 are respectively engaged with the large winches 37 of the compound winches 34 and 35. Such arrangement makes the sliding distance of the first slidable member 14 smaller than the sliding distance of the second slidable member 16.

As such, the length of the force arm of the second slidable member 16 that generates torque in the rotation direction 20 is greatly increased; similarly, the length of the force arm of the second slidable member 16 that generates torque in the reverse rotation direction is greatly shortened.

The embodiment of FIG. 7 shows that the large winch 37 and the small winch 38 are fixedly coupled to the same shaft 41. The shaft 41 is supported by the bearing 42. The large winch 37 and the small winch 38 rotate synchronously with the shaft 41. The embodiment of FIG. 8 shows that the large winch 37 and the small winch 38 are integrated as one body and is inserted into the fixed shaft 43 through a circular through hole so as to rotate synchronously around the shaft 43.

The embodiments shown in FIGS. 1, 2, and 3 all use inclined surfaces to save labor. The inclined surface angle between the second smooth member 15 engaged with the second slidable component 16 and the plane becomes smaller as the wheel rotates. The first slidable member 14 can move the second slidable member 16 with less effort. The specific effect is that it makes the weight of the second slidable member 16 greater than the total weight of the first slidable member 14, the containers 27 and 28, and the loaded substance in the container 27. The result of the extension is that less material can be injected into the container 27 to save water. Or, the weight of the second slidable member 16 is increased, causing the second actuation system to have a greater torque 20 in the rotation direction on the rotation shaft 11.

As shown in FIG. 1, the container 27 engaged with the first slidable member 14 is injected with a substance such as water by the auxiliary system for transporting the substance between about 12 o'clock and 1:30 directions. As the wheel rotates, the inclined angle of the second smooth member 15 engaged with the slidable member 16 and the plane gradually becomes smaller, so as to save effort. However, the first smooth member 13 engaged with the first slidable member 14 becomes more vertical with the horizontal plane and is easier to slide down. Also, after the substance is loaded into the container 27 of the first slidable member 14, the substance is dumped near the vertical axis at 6 o'clock direction, and the substance exerts torque at about 130° on the rotation shaft 11 in the rotation direction 20. The first slidable member 14 slides down between approximately 1:30 and 2 o'clock directions, and pulls the second slidable member 16 through the transmission system, so that the second slidable member 16 slides toward the outside of the wheel away from the rotation shaft 11, increasing the length of the force arm when the second slidable member 16 generates torque on the rotation shaft 11 in the rotation direction 20. Another container 28 engaged with the first slidable member 14 is injected with substance such as water from the side of the rotational wheel by the auxiliary system for transporting substance at about 7:30 direction and slides down at about 7:30 to 8 o'clock directions to pull the second slidable member 16 through the transmission system, so that the second slidable member 16 slides toward the inside of the wheel close to the rotation shaft 11, thereby reducing the length of the force arm during the second slidable member 16 exerting torque on the reverse rotation direction of the rotation shaft 11.

As shown in FIG. 2, the container 27 engaged with the first slidable member 14 is injected with a substance such as water by an auxiliary system (not shown in the figure) for transporting substances after crossing the 12 o'clock vertical axis, resulting in the first slidable member 14 to slide down and pulls the second slidable member 16 through the transmission system, which increases the length of the force arm when the second slidable member 16 generates torque on the rotation shaft 11 in the rotation direction 20. The substance contained in the container 27 finishing dumping at about 4:30 direction, the substance exerts torque at approximately 130° on the rotation shaft 11 in the rotation direction 20; the other container 28 engaged with the first slidable member 14 is loaded with substance near the 6 o'clock vertical axis. The auxiliary system (not shown in the figure) injects substances such as water from the side of the rotational wheel, causing the first slidable member 14 to slide down and pull the second slidable member 16 through the transmission system, reducing the length of the force arm when the second slidable member 16 generates torque in on the rotation shaft 11 opposite to the rotation direction. The substance contained in the container 28 is dumped at approximately 7:30 direction, and the magnitude of the counter-rotating torque produced by the substance on the rotation shaft 11 is approximately 45°.

As shown in FIG. 3, the container 27 engaged with the first slidable member 14 is injected with a substance such as water by an auxiliary system (not shown in the figure) for transporting substances after crossing the 12 o'clock vertical axis. As the wheel rotates, the first smooth member 13 sleeved by the first slidable member 14 becomes more perpendicular to the plane, but the inclined angle between the second smooth member 15 sleeved by the second slidable member 16 and the plane gradually becomes smaller, thus saving effort. The first slidable member 14 slides down between about 12:30 and 2 o'clock directions, and pulls the second slidable member 16 through the transmission system including the compound winch kit 34, 35, which greatly increases the length of the moment arm when the second slidable member 16 produces torque at 20° in the rotation direction on the rotation shaft 11. The substance contained in the container 27 is dumped at about 5 o'clock direction. The magnitude of the torque produced by the substance on the rotation shaft 11 in the rotation direction of 20 is at about 130°. The other container 28 engaged with the first slidable member 14 is injected with a body of water from the side of the rotational wheel by an auxiliary system (not shown in the figure) for transporting substances between about 6 o'clock and 7 o'clock directions. As the wheel rotates, the first smooth member 13 sleeved by the first slidable member 14 becomes more perpendicular to the plane, but the second smooth member 15 sleeved by the second slidable member 16 is vertical to the plane. However, the inclined angle gradually becomes smaller, thus saving effort. The first slidable member 14 slides down at about 7 o'clock direction and pulls the second slidable member 16 through the transmission system including the compound winch kits 34 and 35. The length of the force arm when the second slidable member 16 produces a counter-rotating torque on the rotation shaft 11 is shortened. The substance contained in the container 28 is dumped at about 8 o'clock direction, and magnitude of the counter-rotating torque on the rotation shaft 11 generated by the substance weight produces is approximately 45°.

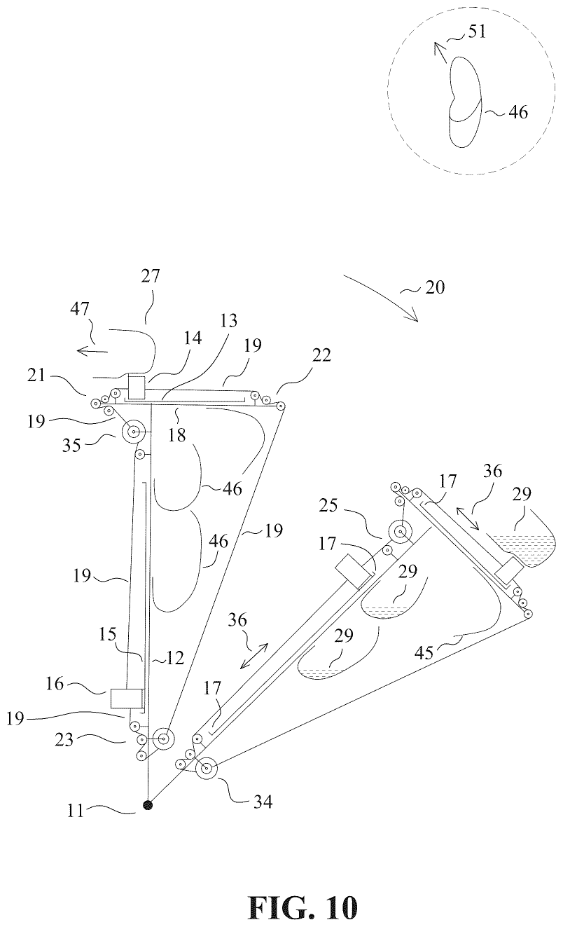

As shown in the embodiments of FIGS. 9 and 10, to facilitate the assembly of the transmission system, the pulley sets 21, 22, 23, and 25 all use the extension structure 33 to support part of the pulleys. The embodiment of FIG. 9 also shows that the blocking member 17 can be installed at the appropriate place of the radial member 12 and the elongated structure 18.

The embodiment of FIG. 10 shows that the compound winch kit can replace the pulley set at a specific position. This embodiment uses a compound winch set 34 to replace the pulley set 24.

The embodiments shown in FIGS. 10, 11, and 12 show that the radial members 12, elongated structures 18, flat strip members 49, etc. of the wheel are combined with concave arc-shaped force-bearing members 44, 45, and 46 with convex surfaces facing the rotation direction 20 at appropriate places. the force-bearing member 46 has the configuration of a curved spoon with a concave arc shape and a wide handle, which is conducive to receiving and retaining water bodies. As such, not only can the additional wind force be used to increase the torque on the rotation shaft 11, but also using more water bodies to drive the wheel, the functions of wind turbines and water turbines are added to increase the operating kinetic energy.

As shown in FIG. 10, the embodiment wherein the first slidable member 14 is only engaged with a container 27 to hold a substance is applicable when the first smooth member 13 has a considerable inclination with the horizontal plane or approaches verticality, the total weight of the first slidable member 14 and the empty container 27 can fall or slide down when the inclination angle between the second smooth member 15 and the horizontal axis or the horizontal plane becomes smaller, so as to pull the second slidable member 16 through the transmission system. However, the auxiliary system for transporting substance still injects water into the container 27 at a high position from 12 o'clock to 1:30 directions, and the water assists in actuating the wheel, and makes the first slidable member 14 slides down at an early time to pull the two slidable members 16, thereby increasing the rotational kinetic energy.

As shown in the embodiment of FIG. 10, the first slidable member 14 is engaged with the container 27 to hold substances. The container 27 is injected a substance such as water after crossing the 12 o'clock vertical axis and before 1:30 direction it at a high position by the auxiliary system (not shown in the figure) independently located next. The overflowing water when the container 27 is injected with water will fall into the concave arc-shaped force-bearing member 46 in the shape of a spoon of the concave arc-shaped wide handles engaged with the same set of radial members 12, and may even fall into the force-bearing member 46 engaged with the previous set of radial members 12, making full use of the overflowing water that can activate the wheel to increase the torque on the rotation axis 11. The water contained in the force-bearing member 46 moves with the rotation of the wheel until it is dumped near the 4 o'clock position, and the dumped water falls into another concave arc-shaped force-bearing member 45 engaged to the elongated structure 18 belonging to the radial member 12 of the same orientation and the same set. The water received by the concave arc-shaped force-bearing member 45 uses a longer force arm to generate a torque on the rotation axis 11 in the rotation direction 20, and the concave arc-shaped force-bearing member 45, like the container 27, rotates until the water is dumped near the 6 o'clock vertical axis, so that the water only produces torque on the rotation axis 11 in the rotation direction 20 without resistance. For the force-bearing members 45 and 46, whether containing water or not, or containing how much water, the wind force can also produce torque on the rotation shaft 11 in the rotation direction 20.

As shown in the embodiments of FIGS. 11 and 12, the container 27 engaged with the first slidable member 14 crossing the 12 o'clock vertical axis will receive water from an auxiliary system (not shown in the figure) independently provided next to the wheel for transporting substances. The water splashed out during injection will fall into the concave arc-shaped force-bearing member 46 with a concave arc-shaped wide handle and a curved spoon shape that is engaged with the same set of radial members 12, and may even fall into the force-bearing member 46 engaged to the radial member 12 of the previous set. The water contained in the force-bearing member 46 will not be dumped until near the 4 o'clock position as the wheel rotates. However, the dumped water will fall into the container 29 of the first slidable member 14 of the radial member 12 of a previous set. Since the empty container 28 of the first slidable member 14 of the radial member is filled with substances in advance, the auxiliary system for transporting substances at a low position can save the amount of water input into the container 28, and the substances can increase the torque generated on the rotation axis in the rotation direction 20 before crossing the vertical axis. The flat strip member 49 in FIG. 11 and the radial member 12 in FIG. 12 are both engaged with a concave arc-shaped force-bearing member 44. For the force-bearing member 44, whether containing water or not, or containing how much water, the wind force can also produce torque on the rotation shaft 11 in the rotation direction 20.

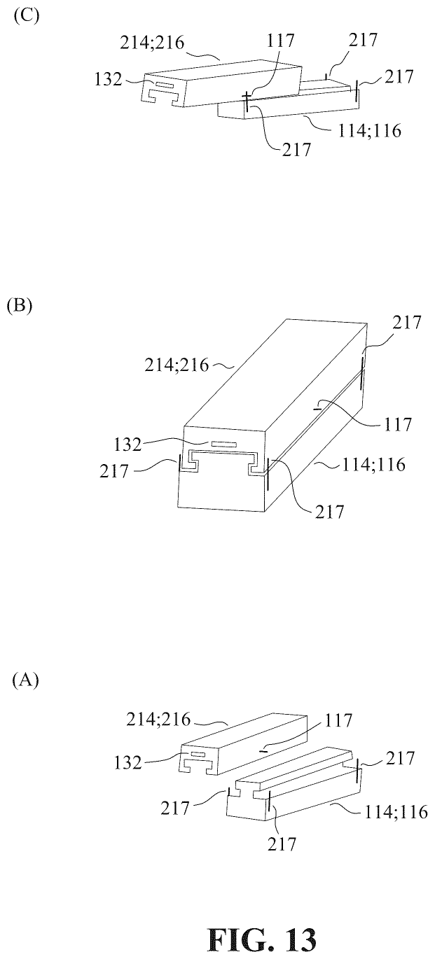

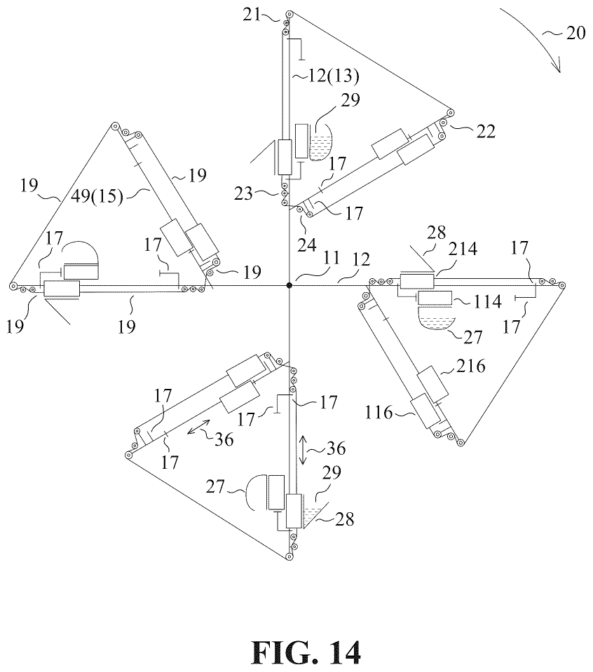

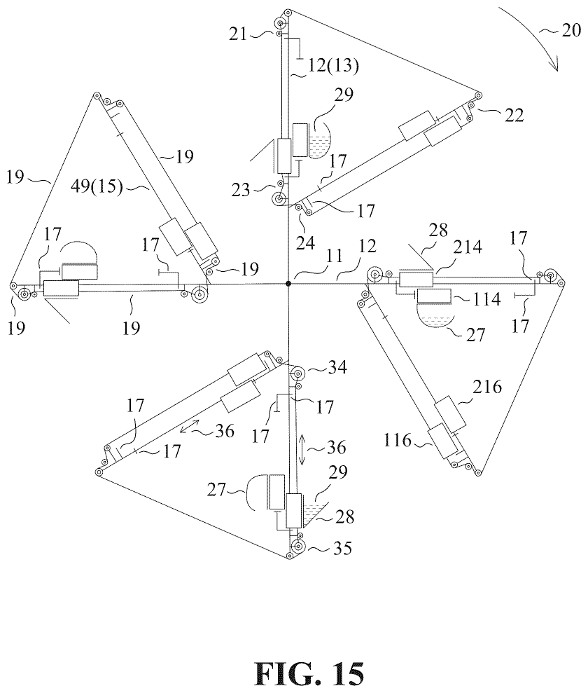

In the embodiment of the combination of FIGS. 13A, B, and C, together with FIGS. 14 and 15, it can be seen that the original first slidable member 14 and the second slidable member 16 further comprise two overlapping and slidable parts. One side of the first part 114 or 116 has an I-shaped protrusion, and one side of the second part 214 or 216 has a groove that allows the I-shaped protrusion of the first part 114 or 116 to be inserted. After the protrusion is inserted in the groove, the first part 114 or 116 and the second part 214 or 216 are slidable with respect to each other. The second part 214 or 216 is provided with stop clips 117 in the middle sections of both sides that are perpendicular to the side with the groove. The first part 114 or 116 is provided with rod-shaped protrusions 217 protruding in the same direction as the I-shaped protrusions at appropriate positions near the four corners. When the first part 114 or 116 and the second part 214 or 216 slide with respect to each other, the first part 114 or 116 will have two rod-shaped protrusions 217 stuck to a stop clip 117 to stop sliding. As such, when a part of the overlapping slidable member slides down or is pulled to slide upward at an oblique angle, the blocking the rod-shaped protrusion 217 with the stop clip 117 will play the role of pulling the other part to slide down at the same time or to be pulled to slide upward at the same time.

FIG. 14 is an extension from the embodiment of FIG. 2. In the embodiments of FIGS. 14 and 15, the radial member 12 also serves as the first smooth member 13, and the flat strip member 49 also serves as the second smooth member 15.

Referring to FIGS. 14 and 15, in combination with the embodiment of FIGS. 13A, B, and C, it can be understood that the second part 214 of the overlapping first slidable member has a slide groove 132 sleeved on the first smooth member 13 to be slidable. The blocking member 17 that stops the second part 214 is originally used to limit the sliding range of the first slidable member 14. By the two blocking members 17 which are first vertically engaged to the first smooth members 13 and then vertically bent towards the rotation shaft 11 and the reverse extension of the rotation shaft 11 to limit the movement range of the first part 114, the first part 114 will be slightly farther away from the rotation shaft 11 than the second part 214 to increase the torsion when the slidable member formed by the first part 114 and the second part 214 generates torque on the rotation shaft 11 in the rotation direction 20. Conversely, when the slidable member formed by the first part 114 and the second part 214 generates a counter-rotating torque to the rotation shaft 11, the first part 114 will be slightly closer to the rotation axis 11 than the second part 214 to reduce the torque.

The second part 216 of the overlapping second slidable member has a slide groove 132 sleeved on the second smooth member 15 to be slidable; the blocking member 17 that stops the second part 216 is originally used to limit the sliding range of the second slidable member 16, the other two blocking members 17 that limit the sliding range of the first part 116 are each closer to the pulleys 22 and 24. When a torque of 20° is generated in the rotation direction and is within the range of 135° from 1:30 to 6 o'clock directions, the first part 116 will be slightly farther away from the rotation axis 11 than the second part 216 to increase the torque; on the other hand, the slidable member formed by the first part 116 and the second part 216 produces a reverse rotational direction torque on the rotation shaft 11, and when the magnitude range is about 135° from 7:30 to 12 o'clock directions, the first part 116 will be slightly closer to the rotation axis 11 than the second part 216 to reduce the torque.

The weight of the first part 114 of the first slidable members is greater than the weight of the second part 214, and the weight of the first part 116 of the second slidable members is greater than the weight of the second part 216. After the slidable member is staggered by half and extended, in most cases, when a torque is exerted on the rotation shaft 11 in the rotation direction 20, the center of gravity will be further away from the rotation shaft 11 and the torque on the rotation shaft 11 will be increased. When a torque is generated on the rotation shaft 11 in the opposite rotation direction, the center of gravity is closer to the rotation shaft 11 and the torque on the rotation shaft 11 is reduced.

In the embodiment of FIGS. 14 and 15, the length of the first slidable members is the same as the length of the second slidable members. In the embodiment of FIG. 14, the length of the sliding distance of the second part 214 of the first slidable members is equal to the length of the sliding distance the first part 116 of the second slidable member.

The embodiment of FIG. 15 is a transmission system comprising four rope-like strip transmission members 19, pulley sets 21-24, and two identical compound winch kits 35, 34 interspersed in the pulley sets 21, 23. The second part 214 with a shorter sliding distance can appropriately pull the first part 116 with a longer moving distance. As shown in FIGS. 7, 8, and 13, the compound winch kit is used in the same manner as the embodiment of FIG. 3. Both ends of the shorter second part 214 with shorter sliding distance facing the sliding direction 36 are respectively engaged with a rope-like strip transmission member 19, and the other ends of the two rope-like strip transmission members 19 are respectively engaged with the small winch 38 of the compound winch kits 34 and 35. The two ends of the first part 116 with a longer moving distance toward the sliding direction 36 are also engaged with a rope-like strip transmission member 19, and the other ends of the two rope-like strip transmission members 19 are respectively engaged with the large winch 37 of the compound winch kits 34 and 35;

The compound winch kits 34 and 35 are identical and both comprises a large winch 37 and a small winch 38 coaxially and rotate synchronously. However, the large winch 37 and the small winch 38 are wound around the rope-like strip transmission member 19 in the opposite directions. When one winch of the same compound winch kit winds and tightens the rope-like strip transmission member 19, the other winch loosens the rope-like strip transmission member 19.

The length that the large winch 37 that winds to tighten or loosen the rope-like strip transmission member 19 is equal to the distance moved by the first part 116 of the second slidable member; the length that the small winch 38 winds to tighten or loosen the rope-like strip transmission member 19 is equal to the sliding distance of the second part 214 of the first slidable member. The use of the compound winch kit makes the sliding distance of the second part 214 smaller than the sliding distance of the first part 116.

Among the two compound winch kits of the same transmission system, the direction in which the large winch 37 of one compound winch kit winds the rope-like strip transmission member 19 connected thereto is different from the direction in which the large winch 37 of the other compound winch kit winds the rope connected thereto. The direction in which the small winch 38 of one compound winch kit winds the rope-like strip transmission member 19 connected thereto is different from the direction in which the small winch 38 of the other compound winch kit winds the rope connected thereto. As such, strip-shaped transmission members 19 wound by the two large winches 37 will be one tightened and the other relaxed, and the strip-shaped transmission members 19 wound by the two small winches 38 will be also one tightened and the other relaxed 38 so as to achieve transmission.

During assembly, lubricating oil should be added to all the following parts so as to ensures smooth operation of the rotational wheel, including: the fitting part of the horizontal rotation shaft 11 and the bearing, the grooves of the first smooth member 13 and the second smooth member 15, the rope-like strip transmission members 19, the pulley sets 21-25, the parallel circular through holes 30, the parallel circular strips 31, the sliding groove 32, the fitting part of the compound winch kit and the fixed shaft 43, the fitting part of the movable shaft 41 fixedly combined with the compound winch kit and the bearing 42, the fitting part of the overlapping first part 114 and the second part 214 of the first slidable members, the fitting part of the first part 116 and the second part 216 of the second slidable member, and the slide groove 132.

In addition, in order to reduce the magnitude and noise of collisions between components, elastic buffering parts, such as rubber, can be provided at locations where two different components come into contact, such as, the blocking member 17 and the first slidable member 14, the second slidable member 16, the first part 114 of the first slidable member, and the second part 214 of the first slidable member, the first part 116 of the second slidable member, the second part 216 of the second slidable member, and so on.

The rotational wheel system of the present invention can be connected with other systems to convert the rotational kinetic energy generated by the wheel into other energy. For example, one side of the horizontal rotation shaft 11 of the rotational wheel is connected to the pivot axis of the bracket used to fix the rotational wheel, and the other side is connected to the pivot axis of the power generation system. As such, the rotational wheel can drive the power generation system, which converts the kinetic energy of the wheel into electrical energy.

The present invention can use a small amount of water as an auxiliary to pull the second slidable member 16, lengthen the length of the force arm when the second slidable member 16 generates torque in the rotation direction, and shorten the length of the force arm when generating torque opposite to rotation direction, thus causing imbalance force arm. Coupled with the torque generated by the weight of the water on the rotation shaft 11 to jointly drive the wheel, when there is no abundant water resource for hydropower generation, a little amount of water can be used as an auxiliary to generate operating kinetic energy. This shows the significance of a powerful power generation solution of the present invention.

When the first actuation system, the second actuation system, and the additional third actuation system all generate torque on the rotation shaft 11 in the rotation direction 20, the entire rotational wheel will generate a good rotational kinetic energy in a compound manner, which is more forward-looking and flexible in the development of kinetic energy.

According to the present invention, when the diameter of the wheel is larger and the rotation speed is slower, it can avoid the problem of delayed sliding of the slidable members due to the influence of inertia during rapid operation. The goal is to output huge rotational kinetic energy through the large wheel diameter and slow rotation speed.

In the embodiment with a third actuation system, when the concave arc-shaped force-bearing members 44, 45, and 46 are pulled by additional wind and water, the rotational kinetic energy of the wheel will increase. In addition, if the available water resources are increased due to seasonal factors, more and heavier water can be input to the container 27 and the force-bearing member 46 from a high direction. When a large amount of water is injected to the container 27 and the force-bearing member 46, large rotational kinetic energy can be generated; and, when the kinetic energy increases significantly, switching devices can be used to switch the large power output from the wheel operation to the generator set that requires greater power.

By arranging the radial members 12 of each wheel evenly in staggering manner at the same angle between two or more identical wheels, and then combining all the wheels together on the same rotation shaft 11, a less fluctuation and greater stable running kinetic energy output can be achieved According to the following formula, after staggering the angles of the radial members 12 of different sets of wheels, a plurality of wheels can be combined on the same horizontal rotation axis 11:
360 degrees÷the number of sets of radial members 12 of a single wheel÷the number of wheels jointly combined to the same horizontal rotation axis 11.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A rotational wheel system by a compound actuation, comprising:
a wheel comprising: a horizontal rotation shaft, and a plurality of radial member assemblies arranged in evenly divided all-around directions, each radial member assembly comprising:
a first smooth member;
a second smooth member, forming in included angle of 45°-90° with the first smooth member;
a first slidable member, engaged to the first smooth member and in a slidable state, and the first slidable member being disposed with two containers with opening at different directions for holding substance;
a second slidable member, engaged to the first smooth member and in a slidable state;
a transmission system, connected to the first slidable member and the second slidable member; and
an auxiliary system for transporting the substance independently arranged on a side of the wheel, and continuously putting the substance into the two containers with two opening directions of the first slidable member at specific orientations at two different heights, upper and lower respectively;
wherein when the containers of the first slidable member is not loaded with the substance, the first slidable member is not heavy enough to slide down and cannot pull the second slidable member; but after the container is loaded with the substance at a higher position, when the first slidable member slides down, the second slidable member is pulled to slide outward away from the rotation shaft through the transmission system, which increases a force arm length when the second slidable member generates a torque on the rotation shaft in a rotation direction; when the container of the first slidable member with the substance input at a lower position slides down, the second slidable member is driven by the transmission system to slide inward closer to the rotation shaft, reducing the force arm length of the second slidable member when generate a torque on the rotation shaft opposite to the rotation direction;
wherein the first slidable member and the second slidable member are both limited in a sliding range by two blocking members;
wherein the first slidable member, the container to hold the substance of the first slidable member, and the substance held by the container together constitute the first actuation system; the second slidable member constitutes the second actuation system; and
the first actuation system and the second actuation system both generate the torque in the same direction on the rotation shaft, so that the wheel can generate a good rotational kinetic energy.

2. The rotational wheel system according to claim 1, wherein the first slidable member and the second slidable member have a same sliding distance.

3. The rotational wheel system according to claim 1, wherein each transmission system comprises two identical compound winch kits, each compound winch kit comprises a large winch and a small winch so that the first slidable member has a smaller sliding distance than the second slidable member.

4. The rotational wheel system according to claim 1, wherein an appropriate part of the wheel is disposed with a concave arc-shaped force-bearing member having a convex surface facing the rotation direction, the arc-shaped force-bearing member can be influenced by wind or water to generate the torque on the rotation shaft to constitute a third actuation system; the first actuation system, the second actuation system, and the third actuation system all generate the torque in the same direction on the rotation shaft, so that the wheel can generate the good rotational kinetic energy.

5. The rotational wheel system according to claim 1, wherein an appropriate part of the wheel is disposed with a concave arc-shaped force-bearing member having a convex surface facing the rotation direction, the concave arc-shaped force-bearing member has a concave arc-shaped wide handle and is in the shape of a curved spoon to facilitate receiving and retaining water, and the water unloaded from the concave arc-shaped force-bearing member with a concave arc-shaped wide handle and in the shape of a curved spoon will fall into another concave arc-shaped force-bearing member at the same orientation so that the water can continue generate the torque on the rotation shaft in the rotation direction.

6. The rotational wheel system according to claim 1, wherein an appropriate part of the wheel is disposed with a concave arc-shaped force-bearing member having a convex surface facing the rotation direction, the concave arc-shaped force-bearing member has a concave arc-shaped wide handle and is in the shape of a curved spoon to facilitate receiving and retaining water, and the water unloaded from the concave arc-shaped force-bearing member with a concave arc-shaped wide handle and in the shape of a curved spoon will fall into the container of the first slidable member of the previous orientation for receiving the substance so that the empty container yet to receive the substance from the auxiliary system will receive the water in advance, so as to make the substance increase the torque on the ration shaft in the rotation direction before crossing the vertical axis, and save the amount of water that the auxiliary system for transporting the substance needs to input into the container at a low position.

7. The rotational wheel system according to claim 1, wherein both the first slidable member and the second slidable member further comprises a first part and a second part which are overlapping and partially slidable with respect to each other, the two blocking members are used to restrict a moving range of the first part and the second part respectively; the second part of the first slidable member has a same sliding distance as the first part of the second slidable member.

8. The rotational wheel system according to claim 1, wherein both the first slidable member and the second slidable member further comprises a first part and a second part which are overlapping and partially slidable with respect to each other, the weight of the first part of the first slidable member is greater than the weight of the second part of the first slidable member, and the weight of the first part of the second slidable member is greater than the weight of the second part of the second slidable member.

9. The rotational wheel system according to claim 1, wherein both the first slidable member and the second slidable member further comprises a first part and a second part which are overlapping and partially slidable with respect to each other, and each transmission system comprises two identical winch kits; a sliding distance of the second part of the first slidable member is less than a sliding distance of the first part of the second slidable member.

10. The rotational wheel system according to claim 1, wherein two or more wheels are jointly engaged to the horizontal rotation shaft.

11. A rotational wheel system by a compound actuation, comprising:
a wheel comprising: a horizontal rotation shaft, and a plurality of radial member assemblies arranged in evenly divided all-around directions, each radial member assembly comprising:
a first smooth member;
a second smooth member, forming in included angle of 45°-90° with the first smooth member;
a first slidable member, engaged to the first smooth member and in a slidable state, and the first slidable member being disposed with a container for holding substance;
a second slidable member, engaged to the first smooth member and in a slidable state;
a transmission system, connected to the first slidable member and the second slidable member; and
an auxiliary system for transporting the substance is independently arranged on a side of the wheel, and continuously inputs the substance into the container of the first slidable member at an upper position;
wherein when the first smooth member is perpendicular to a plane or has a considerable inclination, and a slope angle of the second smooth member to the plane becomes smaller, the first slidable member together with the empty container, whether in a high position between 12 o'clock and 3 o'clock orientations, or a low position between 6 o'clock and 9 o'clock orientations, can slide down and pull the second slidable member through the transmission system; but still the substance is loaded into the container at the high position from 12 o'clock to 1:30 orientations, and a weight of the substance increases a torque on the rotation shaft, which also causes the first slidable member to slide down at an earlier position to affect the second slidable member to slide to an outside away from the rotation shaft, thereby increasing in advance a force arm length when the second slidable member generates the torque on the rotation shaft in a rotation direction;
when the first slidable member together with the empty container sliding downward at low orientations, the second slidable member is pulled by the transmission system to slide toward an inside closer to the rotation shaft, reducing the force arm length when the second slidable member generates a torque opposite to the rotational direction of the rotation shaft;
wherein the first slidable member and the second slidable member are both limited in a sliding range by two blocking members;
wherein the first slidable member, the container to hold the substance of the first slidable member, and the substance held by the container together constitute the first actuation system; the second slidable member constitutes the second actuation system; and
the first actuation system and the second actuation system both generate the torque in the same direction on the rotation shaft, so that the wheel can generate a good rotational kinetic energy.

12. The rotational wheel system according to claim 11, wherein the first slidable member and the second slidable member have a same sliding distance.

13. The rotational wheel system according to claim 11, wherein each transmission system comprises two identical compound winch kits, each compound winch kit comprises a large winch and a small winch so that the first slidable member has a smaller sliding distance than the second slidable member.

14. The rotational wheel system according to claim 11, wherein an appropriate part of the wheel is disposed with a concave arc-shaped force-bearing member having a convex surface facing the rotation direction, the arc-shaped force-bearing member can be influenced by wind or water to generate the torque on the rotation shaft to constitute a third actuation system; the first actuation system, the second actuation system, and the third actuation system all generate the torque in the same direction on the rotation shaft, so that the wheel can generate the good rotational kinetic energy.

15. The rotational wheel system according to claim 11, wherein an appropriate part of the wheel is disposed with a concave arc-shaped force-bearing member having a convex surface facing the rotation direction, the concave arc-shaped force-bearing member has a concave arc-shaped wide handle and is in the shape of a curved spoon to facilitate receiving and retaining water, and the water unloaded from the concave arc-shaped force-bearing member with a concave arc-shaped wide handle and in the shape of a curved spoon will fall into another concave arc-shaped force-bearing member at the same orientation so that the water can continue generate the torque on the rotation shaft in the rotation direction.

16. The rotational wheel system according to claim 11, wherein both the first slidable member and the second slidable member further comprises a first part and a second part which are overlapping and partially slidable with respect to each other, the two blocking members are used to restrict a moving range of the first part and the second part respectively; the second part of the first slidable member has a same sliding distance as the first part of the second slidable member.

17. The rotational wheel system according to claim 11, wherein both the first slidable member and the second slidable member further comprises a first part and a second part which are overlapping and partially slidable with respect to each other, the weight of the first part of the first slidable member is greater than the weight of the second part of the first slidable member, and the weight of the first part of the second slidable member is greater than the weight of the second part of the second slidable member.

18. The rotational wheel system according to claim 11, wherein both the first slidable member and the second slidable member further comprises a first part and a second part which are overlapping and partially slidable with respect to each other, and each transmission system comprises two identical winch kits; a sliding distance of the second part of the first slidable member is less than a sliding distance of the first part of the second slidable member.

19. The rotational wheel system according to claim 11, wherein two or more wheels are jointly engaged to the horizontal rotation shaft.
